(19) United States
(12) Patent Application Publication
(10) Pub. No.: US 2007/0008247 A1
(43) Pub. Date: Jan. 11, 2007

(54) Plasma display device and driving method thereof

(76) Inventors: Byung-Gwon Cho, Chunan-si (KR); Jun-Weon Song, Chunan-si (KR)

Correspondence Address: CHRISTIE, PARKER & HALE, LLP, PO BOX 7068, PASADENA, CA, 91109-7068, US

(21) Appl. No.: 11/472,109

(22) Filed: Jun. 20, 2006

(30) Foreign Application Priority Data
Jul. 6, 2005 (KR) 10-2005-0060677

(51) Int. Cl. G09G 3/28

(52) U.S. Cl. 345/67

(57) ABSTRACT

A plasma display device and a driving method thereof. In a plasma display panel having an opening or a groove between a scan electrode and a sustain electrode, a driving waveform is applied to the scan electrode and an address electrode while the sustain electrode is biased at a predetermined voltage. Then, since a discharge path is formed through the opening or the groove between the scan and sustain electrodes, a discharge firing voltage may be reduced and misfiring prevented in a sustain period.

### CROSS-REFERENCE TO RELATED APPLICATION

This application claims priority to and the benefit of Korean Patent Application No. 10-2005-0060677 filed in the Korean Intellectual Property Office on Jul. 06, 2005, the entire content of which is incorporated herein by reference.

### BACKGROUND OF THE INVENTION

(a) Field of the Invention

The present invention relates to a plasma display device and a driving method thereof.

(b) Description of the Related Art

A plasma display device is a flat panel display that uses plasma generated by a gas discharge process to display characters or images. It includes a plasma display panel (PDP) whereon tens to millions of pixels are provided in a matrix format, depending on its size. Such a PDP is classified as a direct current (DC) type or an alternating current (AC) type according to its discharge cell structure and the waveform of the driving voltage applied thereto.

The DC PDP has electrodes exposed to a discharge space, and accordingly, it allows a DC to flow through the discharge space while a voltage is applied. Therefore, such a DC PDP problematically requires a resistance for limiting the current. On the other hand, the AC PDP has electrodes covered with a dielectric layer that forms a capacitor to limit the current and protects the electrodes from the impact of ions during discharge. Accordingly, the AC PDP has a longer lifetime than the DC PDP.

One frame of the AC PDP is divided into a plurality of subfields, and each subfield includes a reset period, an address period, and a sustain period.

The reset period is for initializing the status of each discharge cell so as to facilitate an addressing operation on the discharge cell, and the address period is for selecting turn-on/turn-off cells, which are the cells that must be turned on or turned off to display the intended image, and for accumulating wall charges on the turn-on cells that are addressed to be turned on. The sustain period is for causing a discharge for displaying an image on the addressed cells.

In order to perform the above-noted operations, sustain pulses are alternately applied to the scan electrodes and the sustain electrodes during the sustain period, and reset waveforms and scan waveforms are applied to the scan electrodes during the reset period and the address period. A scan driving board for driving the scan electrodes and a sustain driving board for driving the sustain electrodes are typically used. However, in this case, a problem arises in mounting the driving boards on a chassis base and the cost tends to increase because of the separate driving boards.

Therefore, for combining the two driving boards into a single combined board, schemes have been proposed wherein the single board is provided to an end of the scan electrodes and an end of the sustain electrodes is extended to reach the combined board. However, when the two driving boards are combined as such, the impedance component formed at the extended sustain electrodes is increased.

### SUMMARY OF THE INVENTION

In accordance with the present invention a plasma display device including an integrated board for driving a scan electrode and a sustain electrode is provided. A driving waveform for the integrated board is also provided.

An exemplary plasma display device according to an embodiment of the present invention includes a PDP and a chassis base. The PDP includes a first substrate and a second substrate located facing each other. A plurality of address electrodes are formed on the first substrate in a first direction. A barrier rib partitions discharge cells in a space between the first and second substrates. A plurality of scan electrodes and a plurality of sustain electrodes are formed on the second substrate in a second direction crossing the direction of the plurality of address electrodes. At least a pair of the plurality of scan and sustain electrodes are located facing each other in each discharge cell. A dielectric layer is formed on the second substrate while covering the plurality of scan and sustain electrodes, the dielectric layer having a groove between at least a pair of the scan and sustain electrodes corresponding to each discharge cell. In a sustain period of at least one subfield, the driving board alternately applies to the plurality of scan electrodes a second voltage and a third voltage that is lower than the second voltage while the plurality of sustain electrodes are biased at a first voltage. The driving board applies a driving waveform to the plurality of address and scan electrodes so as to display an image to the PDP, and biases the plurality of sustain electrodes at the first voltage.

An exemplary driving method of a plasma display device according to an embodiment of the present invention is for driving the plasma display device that includes a PDP having a plurality of first electrodes, a plurality of second electrodes, and a plurality of third electrodes formed in a direction crossing the plurality of first and second electrodes, and a driving board for driving the PDP. According to the driving method, in a sustain period of at least one subfield, a sustain pulse of a second voltage is applied to the plurality of second electrodes while the plurality of first electrodes are biased at a first voltage. A sustain pulse of a third voltage lower than the second voltage is applied to the plurality of second electrodes while the plurality of first electrodes are biased at the first voltage. A discharge firing voltage between the second electrode and the third electrode corresponding to each discharge cell is higher than a discharge firing voltage between the first electrode and the second electrode corresponding to each discharge cell. The PDP further includes a first substrate, second substrate, a barrier rib, and a dielectric layer. The first substrate has the plurality of third electrodes formed thereon. The second substrate has the plurality of first and second electrodes formed thereon. The first and second substrates are formed facing each other. The barrier rib partitions the discharge cells in each space between the first and second substrates. The dielectric layer is formed on the second substrate while covering the plurality of scan and sustain electrodes, and has a groove between at least a pair of the scan and sustain electrodes corresponding to each discharge cell.

### BRIEF DESCRIPTION OF THE DRAWINGS

FIG. 1 shows a simplified exploded perspective view of a plasma display device according to an exemplary embodiment of the present invention.

FIG. 2 shows schematically an electrode arrangement diagram of a PDP according to an exemplary embodiment of the present invention.

FIG. 3 shows a top plan view of a chassis base according to an exemplary embodiment of the present invention.

FIG. 4 shows a driving waveform diagram of a PDP according to an exemplary embodiment of the present invention.

FIG. 5 shows a partial exploded perspective view of a PDP according to an exemplary embodiment of the present invention.

FIG. 6 shows a partial sectional view cut away along a line I to I shown in FIG. 5.

FIG. 7 shows a partial sectional view of the PDP according to an exemplary embodiment of the present invention.

### DETAILED DESCRIPTION OF THE EMBODIMENTS

Wall charges mentioned in the following description mean charges formed and accumulated on a wall (e.g., a dielectric layer) close to an electrode of a discharge cell. The wall charge will be described as being “formed” or “accumulated” on the electrode, although the wall charges do not actually touch the electrodes. Further, a wall voltage means a potential difference formed on the wall of the discharge cell by the wall charge.

A plasma display device according to an exemplary embodiment of the present invention and a driving method thereof will be described with reference to the figures.

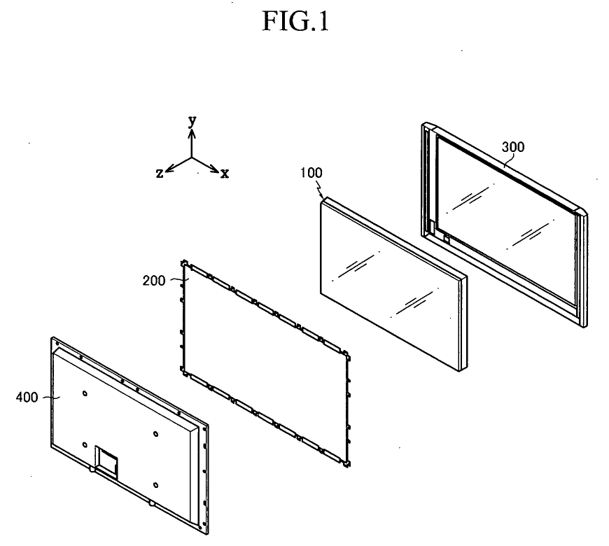

First, a configuration of the plasma display device according to the exemplary embodiment of the present invention will be described with reference to FIG. 1 to FIG. 3. As shown in FIG. 1, the plasma display device according to the exemplary embodiment of the present invention includes a plasma display panel 100, a chassis base 200, a front case 300, and a rear case 400. The chassis base 200 is combined with the plasma display panel 100, being located opposite to an image display side of the plasma display panel 100. Being respectively located at the front of the plasma display panel 100 and the rear of the chassis base 200, the front and rear cases 300, 400 are respectively combined with the plasma display panel 100 and the chassis base 200 to form a plasma display device.

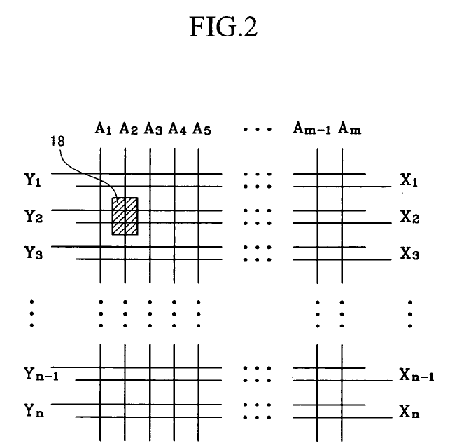

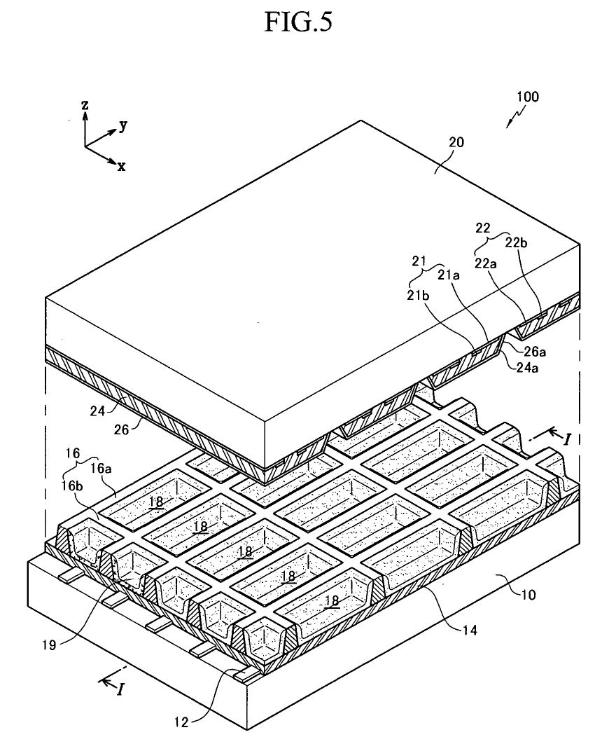

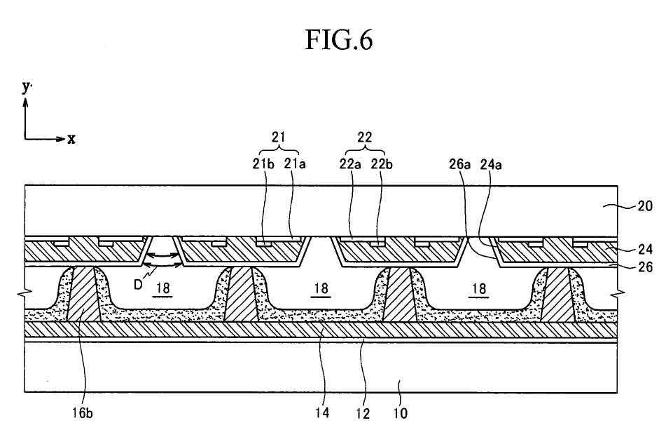

As shown in FIG. 2, the plasma display panel 100 according to the exemplary embodiment of the present invention includes a plurality of address (A) electrodes A1-Am extended in a column direction, and a plurality of scan (Y) electrodes Y1-Yn and sustain (X) electrodes X1-Xn respectively extended in a row direction. The sustain electrodes X1-Xn are formed in respective correspondence to the scan electrodes Y1 -Yn, and ends of the sustain electrodes X1-Xn are connected in common. In addition, the plasma display panel 100 includes an insulation substrate (corresponding to a substrate 20 shown in FIG. 5) having the sustain and scan electrodes X1-Xn and Y1-Yn formed thereon, and another insulation substrate (corresponding to a substrate 10 shown in FIG. 5) having address electrodes A1-Am formed thereon. The two insulation substrates are formed facing each other with an interposed discharge space, and direction of the address electrodes A1-Am perpendicularly cross the direction of the scan electrodes Y1-Yn and sustain electrodes X1-Xn. The discharge space is formed at a region where the address electrode A1-Am crosses the sustain and scan electrodes X1-Xn and Y1-Yn, and such a discharge space forms a cell. A configuration of the PDP 100 for driving waveforms of the plasma display device according to the exemplary embodiment of the present invention will be described later with reference to FIG. 5 and FIG. 6.

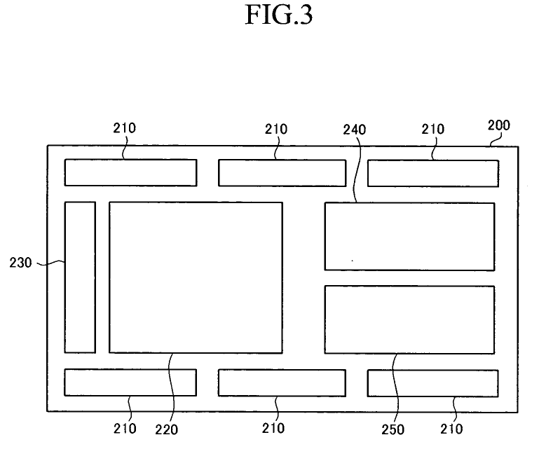

As shown in FIG. 3, driving boards 210, 220, 230, 240, 250 for driving the plasma display panel 100 are formed on the chassis base 200. Address buffer boards 210, shown in upper and lower portions of the chassis base 200, may be formed as a single board or a plurality of boards. It should be noted that FIG. 3 illustrates a plasma display device driven by a dual driving method. However, in the case of a plasma display device driven by a single driving method, the address buffer board 210 is located at either of the upper and lower portions of the chassis base 200. Such an address buffer board 210 receives an address driving control signal from an image processing and controlling board 240, and applies a voltage for selecting turn-on discharge cells (i.e., discharge cells to be turned on) to address electrodes A1 to Am.

As seen in FIG. 3, scan driving board 220 is located at the left on the chassis base 200, and is coupled to the scan electrodes Y1-Yn through a scan buffer board 230. The sustain electrodes X1-Xn are biased at a predetermined voltage. The scan buffer board 230 applies a voltage to the scan electrodes Y1-Yn for sequential selection thereof during an address period. The scan driving board 200 receives driving signals from the image processing and controlling board 240, and applies the driving voltage to the scan electrodes Y1-Yn. In FIG. 3, the scan driving board 220 and the scan buffer board 230 are shown to be located at the left on the chassis base 200. However, they may be located at the right thereon. In addition, the scan buffer board 230 may be integrally formed with the scan driving board 220.

The image processing and controlling board 240, after externally receiving image signals, generates control signals for driving the address electrodes A1-Am and control signals for driving the scan and sustain electrodes Y1-Yn and X1-Xn, and respectively applies them to the address buffer board 210 and the scan driving board 220. A power supply board 250 supplies electric power for driving the plasma display device. The image processing and controlling board 240 and the power supply board 250 may be located at a central area of the chassis base 200.

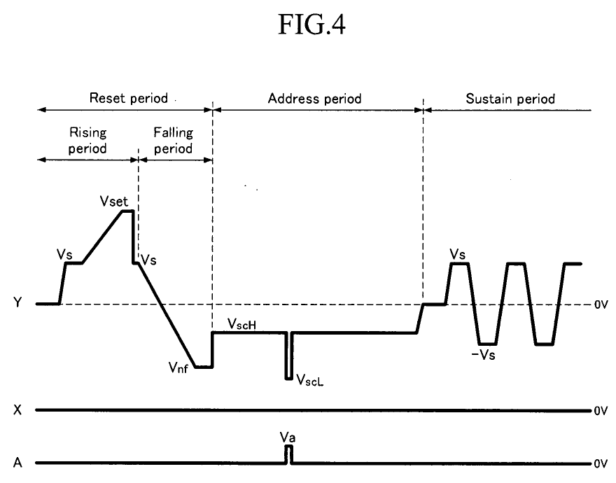

The driving waveform of the plasma display panel according to an exemplary embodiment of the present invention will described with reference to FIG. 4.

FIG. 4 shows the driving waveform diagram of the plasma display panel according to an exemplary embodiment of the present invention. In the following description, the driving waveform applied to a scan (Y) electrode), a sustain (X) electrode, and an address (A) electrode is described in connection with only one cell, but can be applied to other cells in the array. In addition, in the driving waveform shown in FIG. 4, the voltage applied to the Y electrode is supplied from the scan driving board 220 and the scan buffer board 230, and the voltage applied to the A electrode is supplied from the address buffer board 210. Since the X electrode is biased at a reference voltage (refer to ground voltage in FIG. 4), the voltage applied to the X voltage is not described in further detail.

Referring to FIG. 4, a subfield includes a reset period, an address period, and a sustain period, wherein the reset period includes a rising period and a falling period.

During the rising period of the reset period, the voltage of the Y electrode is gradually increased from a voltage Vs to a voltage Vset while maintaining the A electrode at the reference voltage (0V in FIG. 4). FIG. 4 illustrates that the voltage of the Y electrode increases according to a ramp pattern. While the voltage of the Y electrode increases, a weak discharge occurs between the Y and X electrodes and between the Y and A electrodes. Accordingly, negative (−) wall charges are formed on the Y electrode, and positive (+) wall charges are formed on the X and A electrodes. When the voltage of the Y electrode gradually changes as shown in FIG. 4, a weak discharge occurring in a cell forms wall charges such that a sum of an externally applied voltage and the wall charge may be maintained at a discharge firing voltage. Such a process of forming wall charges is disclosed in U.S. Pat. No. 5,745,086 by Weber. The voltage Vset is a voltage high enough to fire a discharge in cells of any condition because every cell has to be initialized in the reset period. In addition, the voltage Vs equals the voltage applied to the Y electrode in the sustain period and is lower than a firing discharge voltage between the Y and X electrodes.

During the falling period of the reset period, the voltage of the Y electrode is gradually decreased from the voltage Vs to a negative voltage Vnf while maintaining the A electrode at the reference voltage. While the voltage of the Y electrode decreases, a weak discharge occurs between the Y and X electrodes and between the Y and A electrodes. Accordingly, the negative (−) wall charges formed on the Y electrode and the positive (+) wall charges formed on the X and A electrodes are eliminated. The voltage Vnf is usually set close to a discharge firing voltage between the Y and X electrodes. Then, the wall voltage between the Y and X electrodes becomes near 0V, and accordingly, a discharge cell that has not experienced an address discharge in the address period may be prevented from misfiring in the sustain period. In addition, the wall voltage between the Y and A electrodes is determined by the level of the voltage Vnf, because the A electrode is maintained at the reference voltage.

Subsequently, during the address period for selection of turn-on cells, a scan pulse of a negative voltage VscL, and an address pulse of a positive voltage Va are respectively applied to Y and A electrodes of the turn-on cells. Non-selected Y electrodes are biased at a voltage VscH that is higher than the voltage VscL, and the reference voltage is applied to the A electrode of the turn-off cells (i.e., cells to be turned off). For such an operation, the scan buffer board 230 selects a Y electrode to be applied with the scan pulse VscL, among the Y electrodes Y1 to Yn. For example, in a single driving method, the Y electrode may be selected according to an order of arrangement of the Y electrodes in the column direction. When a Y electrode is selected, the address buffer board 210 selects turn-on cells among cells formed on the selected Y electrode. That is, the address buffer board 210 selects A electrodes to which the address pulse of the voltage of Va is applied among the A electrodes A1 to Am

In more detail, the scan pulse of the voltage VscL is first applied to the scan electrode (Y1 shown in FIG. 2) of a first row, and at the same time, the address pulse of the voltage Va is applied to an A electrode on a turn-on cell in the first row. Then a discharge is generated between the Y electrode of the first row and the A electrode applied with the voltage Va, and accordingly, positive (+) wall charges are formed on the Y electrode and negative (−) wall charges are formed on the A and X electrodes. As a result, a wall voltage Vwxy is formed between the X and Y electrodes such that a potential of the Y electrode becomes higher than a potential of the X electrode. Subsequently, the address pulse of the voltage Va is applied to the A electrodes of turn-on cells in a second row while the scan voltage of the voltage VscL is applied to the Y electrode (Y2 shown in FIG. 2) in the second row. Then, the address discharge is generated in the cells crossed by the A electrodes applied with the voltage Va and the Y electrode in the second row, and accordingly, the wall charges are formed in such cells, in the same manner as described above. Regarding Y electrodes in other rows, wall charges are formed in turn-on cells in the same manner as has been described above, i.e., by applying the address pulse of the voltage Va to A electrodes on turn-on cells while sequentially applying a scan pulse of the voltage VscL to the Y electrodes.

In such an address period, the voltage VscL is usually set to be equal to or less than the voltage Vnf, and the voltage Va is usually set to be greater than the reference voltage. The generation of the address discharge by applying the voltage Va to the A electrode is described below in the case where the voltage VscL equals the voltage Vnf. When the voltage Vnf is applied in the reset period, a sum of the wall voltage between the A and Y electrodes and the external voltage Vnf between the A and Y electrodes reaches the discharge firing voltage Vfay between the A and Y electrodes. When the A electrode has a voltage OV applied and the Y electrode has a voltage VscL (=Vnf) applied, the voltage Vfay is formed between the A and Y electrodes, and accordingly the discharge may be expected to be generated. However, in this case, the discharge is not generated because a discharge delay is greater than the width of the scan pulse and the address pulse. However, if the voltage Va is applied to the A electrode while the voltage VscL(=Vnf) is applied to the Y electrode, a voltage greater than the voltage Vfay is formed between the A and Y electrodes such that the discharge delay is reduced less than the width of the scan pulse. Therefore in this case, the discharge may be generated. At this time, generation of the address discharge may be facilitated by setting the voltage VscL to be less than the voltage Vnf.

Subsequently, in the sustain period sustain discharge is triggered between the Y and X electrodes by initially applying a pulse of voltage Vs to the Y electrode, since, in the cells that have experienced an address discharge in the address period, the wall voltage Vwxy is formed such that the potential of the Y electrode is higher than the potential of the X electrode. In this case, the voltage Vs is set such that it is lower than the discharge firing voltage Vfxy and a voltage value Vs+Vwxy is higher than the voltage Vfxy. As a result of such a sustain discharge, negative (−) wall charges are formed on the Y electrode and positive (+) wall charges are formed on the X and A electrodes, such that the potential of the X electrode is higher than the potential of the Y electrode.

Now, since the wall voltage Vwxy is formed such that the potential of the Y electrode becomes higher than the potential of the X electrode, a sustain pulse of a negative voltage −Vs is applied to the Y electrode to fire a subsequent sustain discharge. Therefore, positive (+) wall charges are formed on the Y electrode and negative (−) wall charges are formed on the X and A electrodes, such that another sustain discharge may be fired by applying the voltage Vs to the Y electrode. Subsequently, the process of alternately applying the sustain pulses of voltages Vs and −Vs to the scan electrode Y is repeated by the number corresponding to a weight value of a corresponding subfield.

As described above, according to the first embodiment of the present invention, reset, address, and sustain operations may be performed by a driving waveform applied only to the Y electrode while the X electrode is biased at the reference voltage. Therefore, a driving board for driving the X electrode is not required, and the X electrode may be simply biased at the reference voltage.

Still referring to FIG. 4, in the falling period of the reset period according to the exemplary embodiment of the present invention, a final voltage applied to the Y electrode is set to Vnf voltage. The final voltage Vnf is set close to the discharge firing voltage between the Y and X electrodes as described above. In general, since the discharge firing voltage Vfay between the Y and A electrodes is lower than the discharge firing voltage Vfxy between the Y and X electrodes, at the final voltage Vnf of the falling period, the potential of the Y electrode caused by the wall charges becomes higher than the potential of the A electrode. Accordingly, a wall voltage Vway at the Y electrode with respect to the A electrode is set to a positive voltage. In addition, while maintaining a wall charge state of the falling period in a discharge cell that has not experienced an address discharge in the address period, the sustain period begins. Therefore, misfiring may occur when the Vs voltage is applied to the Y electrode in the sustain period of the discharge cell that has not experienced the address discharge in the address period. That is, the wall voltage Vway at the Y electrode corresponding to the A electrode may be set to the positive voltage at the final voltage Vnf of the falling period, and the misfiring may occur when the Vs voltage is applied to the Y electrode in the sustain period since the discharge cell that has not experienced the address discharge in the address period maintains the wall charge state of the falling period.

A configuration of the PDP for solving a misfiring problem caused when the driving waveform shown in FIG. 4 is applied will now be described with reference to FIG. 5 and FIG. 6.

FIG. 5 shows a partial exploded perspective view of the PDP 100 according to an exemplary embodiment of the present invention. The PDP includes a first substrate 10 (hereinafter, referred to as a “rear substrate”) and a second substrate 20 (hereinafter, referred to as a “front substrate”), which are positioned substantially parallel with each other with a predetermined distance therebetween. The PDP includes a plurality of discharge cells 18 between the front and rear substrates, the discharge cells 18 being partitioned by barrier ribs 16.

A plurality of address electrodes 12 are formed along a direction (in a Y axis direction in FIG. 5) on a surface of the rear substrate 10 facing the front substrate 20. In addition, covering the address electrodes 12, a dielectric layer 14 is formed on the surface of the rear substrate 10. The address electrodes 12 are formed substantially parallel to each other while maintaining a predetermined spacing between adjacent address electrodes 12. In addition, the address electrodes 12 shown in FIG. 5 correspond to the address electrodes A1 to Am shown in FIG. 2.

The barrier rib 16 partitioning the plurality of discharge cells 18 is formed on the dielectric layer 14. The barrier rib 16 includes first rib members 16a formed substantially in parallel with the address electrodes 12 (i.e., in the y-axis direction shown in FIG. 5), and second barrier rib members 16b formed in a direction (i.e., x-axis direction in FIG. 5) crossing the direction of the address electrodes 12. The present invention should not be understood to be limited to the above described barrier rib structure. On the contrary, the present invention may be applied to various barrier rib structures such as a striped structure in which the barrier rib members are formed only in parallel with the address electrodes, and such a barrier rib structure should be understood to lie within the spirit and scope of the present invention.

A phosphor layer 19 is formed on a rear substrate side in each discharge cell 18, and discharge gas (e.g., Ne-Xe compound gas) for generating a predetermined discharge and emitting light is filled therein. The phosphor layer 19 may be formed by a reflective phosphor so that a visible light generated by the predetermined discharge may be reflected toward the front substrate 20.

On a surface of the front substrate 20, the surface facing the rear substrate 10, scan and sustain electrodes 21, 22 are formed in a direction (i.e., an x-axis direction shown in FIG. 5) crossing the direction of the address electrode 12. The scan and sustain electrodes 21, 22 respectively include bus electrodes 21b, 22b extended in the direction crossing the address electrodes 12, and protrusion electrodes 21a, 22a protruding from the bus electrodes 21b, 22b toward a center of the discharge cell 18. A pair of the bus electrodes 21b, 22b, for example, may correspond to each discharge cell 18, and a pair of the protrusion electrodes 21a, 22a is formed facing each other in each discharge cell 18. The scan and sustain electrodes 21, 22 shown in FIG. 5 respectively correspond to the scan and sustain electrodes Y1 to Yn and X1 to Xn shown in FIG. 2.

The protrusion electrodes 21a, 22a are for causing a plasma discharge in the discharge cell 18, and they may be formed of, for example, indium tin oxide (ITO) which is a transparent material, for maintaining a sufficient aperture ratio. The bus electrodes 21b, 22b are used for providing sufficient conductivity of the display electrodes by compensating for the high electric resistance of the protrusion electrodes 21a, 22a, and may be formed as an opaque metal material.

A dielectric layer 24 is formed on the front substrate 20, covering the scan and sustain electrodes 21, 22. According to the exemplary embodiment of the present invention, an opening 24a exposing a part of the front substrate 20 is formed on the surface of the front substrate 20 facing the rear substrate 10.

An MgO protective layer 26 is formed on the front substrate 20, covering the dielectric layer 24. An opening 26a is formed in an area of the MgO protective layer 26, the area corresponding to the opening 24a of the dielectric layer 24. The MgO protective layer 26 protects the dielectric layer 24 from collisions of ions during the plasma discharge, and enhances discharge efficiency due to its high secondary electron emission coefficient.

FIG. 6 shows a partial sectional view cut away along a line I to I shown in FIG. 5. The opening 24a of the dielectric layer 24 in the exemplary embodiment of the present invention is formed in a central area of each discharge cell 18 and between the protrusion electrodes 21a, 22a facing each other.

The opening 24a of the dielectric layer 24 reduces a discharge path D formed between the scan electrode 21 and the sustain electrode 22. That is, the discharge path D is reduced since it may be formed straight by forming the opening 24a between the scan and sustain electrodes 21, 22. Since the discharge path D is reduced according to the exemplary embodiment of the present invention, a discharge firing voltage Vfxy generated between the scan and sustain electrodes 21, 22 may be reduced.

Rather than exposing the part of the front substrate 20 by forming the opening by the parts 24a, 26a in FIG. 5 and FIG. 6, the dielectric layer 24 and the MgO protective layer 26 may be formed on an area corresponding to the opening of the front substrate 20 in FIG. 6 due to a problem caused by a manufacturing process.

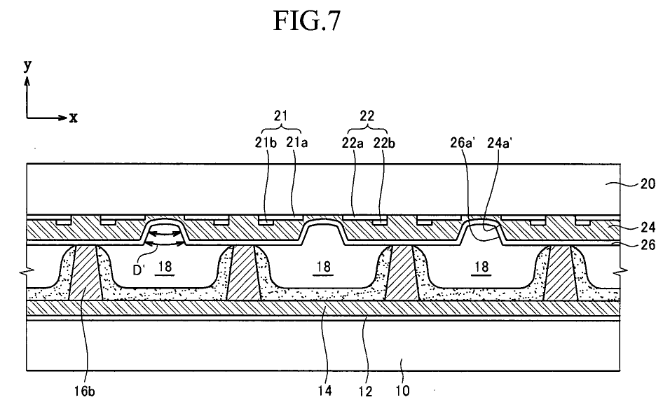

FIG. 7 shows a partial sectional view of the PDP according to another exemplary embodiment of the present invention. Due to the problem caused by the manufacturing process, a groove 24a′ is formed since the dielectric layer 24 and the MgO protective layer 26 are slightly formed on the front layer 20 between the scan and sustain electrodes 21, 22 rather than partly exposing the front substrate 20. In addition, a groove 26a′ is formed in an area on the MgO protective layer 26, the area corresponding to the groove 24a′ of the dielectric layer 24. Since the discharge path D′ formed between the scan and sustain electrodes 21, 22 is reduced by the groove formed by the parts 24a′, 26a′ of the dielectric layer 24 and the MgO protective layer 26 shown in FIG. 7, the discharge firing voltage Vfxy between the scan and sustain electrodes 21, 22 may be reduced.

As described, the misfiring caused by applying the driving waveform shown in FIG. 4 may be prevented since the discharge firing voltage Vfxy between the scan and sustain electrodes 21, 22 is reduced in the PDP shown in FIG. 5 to FIG. 7. Since a distance between the scan and address electrodes 21, 12 is maintained, the discharge firing voltage Vfay between the scan and address electrodes 21, 12 is also maintained. In a like manner of the PDP 100 according to the exemplary embodiment of the present invention, when the discharge firing voltage Vfxy between the scan and sustain electrodes 21, 22 is reduced and the discharge firing voltage Vfay between the scan and address electrodes 21, 12 is maintained, the (+) wall charges are formed relatively less on the scan electrode between the scan and address electrodes 21, 12 at the final voltage Vnf of the falling period. Therefore, the misfiring in the sustain period is prevented since the wall voltage at the scan electrode 21 with respect to the address electrodes 12 is reduced. In addition, when the discharge firing voltage Vfxy between the scan and sustain electrodes 21, 22 is less than the discharge firing voltage Vfay between the scan and address electrodes 21, 12, the misfiring in the sustain period may be further reduced since the (−) wall voltage is formed on the scan electrode 21 between the scan and address electrodes 21, 12. A level of the Vs voltage which is the sustain pulse voltage is determined by the discharge firing voltage Vfxy between the scan and sustain electrodes 21, 22, and the Vs voltage may be set to a further lower level when the discharge firing voltage Vfxy is low. Therefore, in the like manner of the PDP according to the exemplary embodiment of the present invention, when the Vs voltage is set to the low level since the discharge firing voltage Vfxy between the scan and sustain electrodes 21, 22 is low, the misfiring may be further prevented since a low voltage difference is applied to the scan and address electrodes 21, 12 when the Vs voltage is applied to the scan electrode in the sustain period. In this case, since the discharge firing voltage Vfay is maintained between the scan and address electrodes 21, 12, the misfiring is prevented between the scan and address electrodes 21, 12 when the low level of the Vs voltage is applied.

According to the exemplary embodiment of the present invention, since the driving waveform is applied only to the scan electrode while the sustain electrode is biased at a predetermined voltage, a driving board for driving the sustain electrode may be eliminated, and therefore a manufacturing cost is reduced.

In addition, the discharge path is reduced since the discharge path is formed through the opening or the groove formed between the scan and sustain electrodes, and therefore the discharge firing voltage may be reduced, and the misfiring in the sustain period may be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plasma display panel having:
a first substrate and a second substrate located facing each other,
a plurality of address electrodes formed on the first substrate in a first direction,
a barrier rib partitioning discharge cells in a space between the first substrate and the second substrate,
a plurality of scan electrodes and a plurality of sustain electrodes formed on the second substrate in a second direction crossing a direction of the plurality of address electrodes, a scan electrode and sustain electrode pair facing each other in each discharge cell, and
a dielectric layer formed on the second substrate and covering the plurality of scan electrodes and the plurality of sustain electrodes, the dielectric layer having a groove between each of the scan electrode and sustain electrode pair; and
a chassis base having a driving board applying a voltage for driving the plurality of address electrodes, the plurality of scan electrodes, and the plurality of sustain electrodes, the chassis base facing the plasma display panel,
wherein, in a sustain period of at least one subfield, the driving board alternately applies to the plurality of scan electrodes a second voltage and a third voltage lower than the second voltage while the plurality of sustain electrodes are biased at a first voltage.

2. The plasma display device of claim 1, wherein the driving board applies a driving waveform to the plurality of address electrodes and the plurality of scan electrodes for displaying an image to the plasma display panel, and biases the plurality of sustain electrodes at the first voltage.

3. The plasma display device of claim 1, wherein a discharge firing voltage between a scan electrode and an address electrode corresponding to a discharge cell is higher than a discharge firing voltage between the scan electrode and a sustain electrode corresponding to the discharge cell.

4. The plasma display device of claim 1, wherein an absolute value of the second voltage is the same as an absolute value of the third voltage, and the second voltage and the third voltage have a reverse phase from each other.

5. The plasma display device of claim 1, wherein each of the plurality of scan electrodes and each of the plurality of sustain electrodes include:
a bus electrode elongated in the second direction, and
a protrusion electrode protruding from the bus electrode toward a center of a corresponding discharge cell.

6. The plasma display device of claim 5, wherein the groove of the dielectric layer is formed between protrusion electrodes facing each other.

7. The plasma display device of claim 1, wherein each groove of the dielectric layer corresponds with a center of a respective discharge cell.

8. The plasma display device of claim 1, wherein the first voltage is a ground voltage.

9. The plasma display device of claim 1, wherein:
an MgO protective layer is formed on the second substrate and covers the dielectric layer, and
another groove is formed in an area of the MgO protective layer corresponding to the groove of the dielectric layer.

10. The plasma display device of claim 1, wherein the second substrate is partly exposed by the groove of the dielectric layer.

11. A driving method for driving a plasma display device including a plasma display panel plasma display panel having a plurality of first electrodes, a plurality of second electrodes, and a plurality of third electrodes formed in a direction crossing a direction of the plurality of first electrodes and the plurality of second electrodes, and a driving board driving the plasma display panel, the driving method comprising in a sustain period of at least one subfield:
applying a sustain pulse of a second voltage to the plurality of second electrodes while the plurality of first electrodes are biased at a first voltage; and
applying a sustain pulse of a third voltage lower than the second voltage to the plurality of second electrodes while the plurality of first electrodes are biased at the first voltage,
wherein a discharge firing voltage between a second electrode and a third electrode corresponding to a discharge cell is higher than a discharge firing voltage between a first electrode and the second electrode corresponding to the discharge cell.

12. The driving method of claim 11, wherein the plasma display panel further comprises:
a first substrate having the plurality of third electrodes, and
a second substrate having the plurality of first electrodes and the plurality of second electrodes, the second substrate facing the first substrate;
a barrier rib partitioning the discharge cells in each space between the first substrate and the second substrate; and
a dielectric layer formed on the second substrate and covering the plurality of scan electrodes and the plurality of sustain electrodes, the dielectric layer having a groove between each pair of a scan electrode and a sustain electrode corresponding to a discharge cell.

13. The driving method of claim 11, wherein the at least one subfield further comprises a reset period and an address period, and a driving waveform is applied to the plurality of second electrodes and the plurality of third electrodes while the plurality of first electrodes are biased at the first voltage in the reset period and in the address period.

14. The driving method of claim 11, wherein an absolute value of the second voltage is the same as an absolute value of the third voltage, and the second voltage and the third voltage have a reverse phase from each other.

15. The driving method of claim 12, wherein:
an MgO protective layer is formed on the second substrate and covers the dielectric layer, and
another groove is formed in an area of the MgO protective layer, the area corresponding to the groove of the dielectric layer.

16. The driving method of claim 11, wherein the first voltage is a ground voltage.

17. The driving method of claim 12, wherein the second substrate is partly exposed by the groove of the dielectric layer.
